(19) United States
(12) Patent Application Publication
(10) Pub. No.: US 2008/0095676 A1
(43) Pub. Date: Apr. 24, 2008

(54) Multiple Bio-Reactor Device

(75) Inventor: Carlo Andretta, Uitikon-Waldegg (CH)

Correspondence Address: COHEN, PONTANI, LIEBERMAN & PAVANE, 551 FIFTH AVENUE, SUITE 1210, NEW YORK, NY, 10176, US

(73) Assignee: Biospectra AG, Schlieren (CH)

(21) Appl. No.: 11/632,867

(22) PCT Filed: Jul. 26, 2005
(86) PCT No.: PCT/CH05/00440

§ 371 Date: Jun. 25, 2007

(30) Foreign Application Priority Data
Jul. 29, 2004 (CH) 1273/04

(51) Int. Cl. B01J 19/00

(52) U.S. Cl. 422/188

(57) ABSTRACT

A multiple bio-reactor device comprising a plurality of reactor segments, wherein a reaction vessel and at least one supply vessel can be secured to each reactor segment in a medium-tight suspended manner. A plurality of processing stations is provided in order to carry out predetermined processing steps with respect to the reaction vessel and/or supply vessels of each reactor segment, wherein an actuator is provided, in order to bring each reactor segment to a respective processing station or vice-versa. A respective reactor segment comprises a sterilizable domain that encompasses at least the reaction vessel and part of the reaction segment located thereabove.

### TECHNICAL FIELD

The present invention relates to a multiple bio-reactor device according to the preamble of claim 1.

### PRIOR ART

The development and optimization of bio-processes that are used, for example, in pharmaceutical industry, food technology or in other industrial fields usually requires a careful investigation of numerous parameters. In particular, large numbers of fermentations need to be carried out under various reaction and culture medium conditions and, if necessary, various clones have to be tested. A traditional approach to his end relies on systematically conducting individual reaction trials in appropriate reactors, although this is very time-consuming and cost-intensive due to the large number of trials that are usually required.

By using series of simultaneously performed tests a considerable acceleration and cost saving can be achieved as compared to the conventional approach, and this is also known by the term “high throughput bio-processing”. Appropriate devices are known in chemical analytics and comprise, in particular, carousel systems with rotatable sample carriers and various operating arms and measuring devices. Examples are described in U.S. Pat. No. 3,788,816, FR 2,258,625, U.S. Pat. No. 4,170,625 and U.S. Pat. No. 5,358,691.

However, the above mentioned analysis devices are not suitable for parallel examination and optimization of bio-reactions under monoseptic conditions. The devices described in U.S. Pat. No. 3,788,816, FR 2,258,625, U.S. Pat. No. 4,170,625 and U.S. Pat. No. 5,358,691 each comprise a plurality of sample containers resting with their lower base portion on a lower platform and/or hanging with their upper collar portion on an upper support, with the upper openings of the containers being open. Thus, the various containers are easily accessible for various operating elements such as transfer pipettes and the like. Although a foil-like cover for a group of containers is described in FR 2,258,625 with reference to FIG. 20, it is only a protection for transport and storage. The actual handling of the containers requires removal of the foil in order to allow an approach from the top. Furthermore, U.S. Pat. No. 5,358,691 with reference to FIG. 15 describes a chamber with controlled air stream and temperature conditions comprising a rotating table with a plurality of sample containers; however, a parallel operation of several bio-reactors under individual monoseptic conditions cannot be accomplished.

A related multiple bio-reactor device is described in U.S. Pat. No. 6,673,532 B2. The device comprises a matrix-like arrangement with 96 miniaturized bioreactors. The various bio-reactors thereof are formed by trough-shaped recesses in a support plate, wherein each reactor has a volume of about 250 μl. Such small reaction volumes require a corresponding miniaturization of the devices to be inserted for handling and analysis of the reaction mixtures, which ultimately results in a restriction of the possible processing steps.

Moreover, an important disadvantage of microreactors of the kind described above is that certain aspects that are important for large scale bioreactions do not have any effect in a microreactor and, therefore, cannot be simulated. In particular, this relates to the effects of stirring reaction solutions, which encompasses a transformation of mechanical energy into heat and is not an issue in a microreactor. The small dimensions of a microreactor also imply that important key variables such as the ratio of surface to volume and various rheologic variables have completely different values to those in a laboratory reactor and even more so to those in a production reactor.

### DESCRIPTION OF THE INVENTION

It is an object of the present invention to provide an improved multiple bio-reactor device that overcomes the disadvantages of prior art.

This object is achieved by the device defined in claim 1.

The device according to the present invention comprises a plurality of reaction vessels and further comprises a plurality of reactor segments. A reaction vessel and at least one supply vessel can be secured to each reactor segment in a medium-tight suspended manner, the aforesaid together forming a reaction unit. Moreover, the device of the present invention comprises a plurality of processing stations for carrying out predetermined processing steps within each reaction unit, i.e. with the reaction vessel and/or the supply vessels of each reactor segment. Furthermore, actuator means are present for bringing each reactor segment to a respective processing station or vice-versa. Each reactor segment comprises a sterilizable domain that encompasses at least the reaction vessel and part of the reaction segment located thereabove.

The device according to the present invention allows for parallel performance of a plurality of bio-processes. Thereby, each reaction unit takes the function of an individual bio-reactor device that comprises a reaction vessel and also one or several supply vessels. The latter are intended, in particular, for the storage of culture media and also for bases and acids in order to set a desired pH value in the reaction mixture. By virtue of the fact that each reactor segment can be brought to a respective processing station or vice-versa, only one unit is required for each one of the various types of processing stations. Moreover, the modular construction with various reactor segments is advantageous with regard to searching and repairing possible malfunctions, because a damaged reactor segment can be replaced with an identical replacement unit.

By virtue of the fact that each reactor segment is provided with a sterilizable domain that encompasses at least the reaction vessel and part of the reaction segment located thereabove, a bioreaction can be carried out in each reaction vessel under individual monoseptic conditions. In particular, a cross-contamination between the various reaction vessels can be avoided.

Advantageous embodiments of the invention are defined in the dependent claims.

In principle, the individual reactor segments could be realized, for example, as square or rectangular-shaped units and could be arranged in one or several planes. However, it is advantageous if, in accordance with claim 2, the individual reactor segments are sector-shaped and together form a substantially toroidal reactor table. Moreover, it is particularly advantageous if, in accordance with claim 3, the processing stations are arranged star-like around a central axis of the reactor table, wherein reactor segments and processing stations can be brought to each other by a rotation about the central axis. It is convenient, but not mandatory to provide a reactor table that is rotatable about the central axis rather than providing rotatable processing stations. Depending on the function of the individual processing stations, these are arranged to be moved in a radial direction in order to reach various positions of a reactor segment. As a result of the rotatable embodiment of the multiple bio-reactor device, a substantially more space-saving construction can be achieved as compared to the known devices, and this allows a parallel processing on a laboratory scale with a reactor volume of e.g. about 0.5 L.

Claim 4 defines preferred embodiments of the processing stations, which, in particular, can be realized as cleaning station, as calibration station, as sterilization station, as filling station, as inoculation station and as sampling station. The cleaning station allows applying appropriate cleaning agents to components of the reactor device and, in particular, to the reaction vessels that need to be cleaned. Such cleaning processes are well known from laboratory technology and are also termed as CIP procedures (engl. “Cleaning In Place”). The calibration station is intended for calibration of pH probes and optionally of other probes. The sterilization station is used for sterilization of parts of the bio-reactor device intended therefor, wherein this is preferably achieved with superheated water steam. The filling station allows filling the individual vessels of a reactor segment with previously prepared media components. In an analogous way, the inoculation is used for automated inoculation of the individual reaction vessels, wherein various operating modes are possible. In particular, all reaction vessels of the multiple bio-reactor device can be inoculated with the same clone, or each reaction vessel is inoculated with a different clone. The sampling station is generally used for analysis of the reaction mixtures that are present in the reaction vessels and comprises, in particular, measuring modules for the determination of biotechnologically relevant variables such as optical density, glucose concentration, enzymatic activity and so on.

Claims 5 to 10 define preferred embodiments of the reactor segments. According to claim 5, each reactor segment is formed of several segment layers stacked on top of each other, wherein the individual segment layers are provided with milled grooves and/or boreholes and/or isolation devices that form a channel system for liquids and/or gases. Advantageously, in accordance with claim 6, a number of lower segment layers are made of stainless steel, wherein these layers form part of the sterilizable domain. According to claim 7, the channel system comprises a ring line for supplying gases from a central injection point to the individual reactor segments. Advantageously, the ring line is also sterilizable. According to claim 8, each reactor segment is provided with pneumatically operated valves, each valve cooperating with at least one corresponding contact portion of a segment layer acting as valve seat. In this way a very compact construction of the means for gas and liquids distribution can be achieved, which has also a favorable effect in terms of the space required by the individual building units and is thus advantageous for the dimensioning of the entire multiple bio-reactor device. Advantageously, in accordance with claim 9, the valves are arranged within the reactor segments, a number of upper segment layers forming a distribution system for supplying pressurized air or another pneumatic medium for controlling the valves. For example, each reactor segment comprises three lower layers made of stainless steel comprising a sterilizable domain for conduction of liquids and/or gases intended for the respective bioreactions, and it further comprises four upper layers made of aluminum that are provided for housing and handling the valves and also for distribution of driving air.

Moreover, the embodiment according to claim 10 is particularly advantageous, according to which each valve comprises a rocking member that can be brought into a first and a second rocking position, respectively, by applying and releasing a pneumatic pressure, respectively, wherein the rocking member is connected to at least one plunger element in such a way that the plunger element in one of the two rocking positions forms a medium-tight closure with the corresponding contact portion and that the plunger element releases the medium-tight closure when it is in the other one of the two rocking positions. In this way, it is possible to realize in particular so-called 3/2-way and 2/2-way valve couplings, respectively, which results in a substantial flexibility concerning the specific design of the channel system but also for the handling of the multiple bio-reactor device.

Advantageously, in accordance with claim 11, the bio-reactor device is provided with tube-like load cells, wherein each load cell forms a medium-tight connection between the reactor segment and a reaction vessel or supply vessel secured thereto. This allows recording of the vessel weight periodically or at sporadic time intervals or even in a continuous manner. In turn, this allows a simple and automated handling of the filling and dosing procedures. Moreover, the bio-process can be tracked and balanced gravimetrically.

In the embodiment defined in claim 12 each reactor segment is provided with at least one sterilizable coupling unit in order to form a connection between a reaction vessel or supply vessel arranged at said reactor segment and a processing station arranged thereabove, wherein said connection optionally can be maintained sterile. In this way, the required processing steps that have to be carried out by the processing stations at the individual vessels can be performed under sterile conditions if required. It is particularly advantageous if, in accordance with claim 13, the coupling unit comprises a ball valve that in its open position clears a substantially vertical passing channel. This allows for good access from the processing stations to the vessels arranged thereunder so that, for example, handling fingers, sensors, sampling tubes and the like can be lowered into the vessels.

In the embodiment of claim 14 it is envisioned that the bio-reactor device comprises a respective stirring device for each reaction vessel. Particularly advantageous is the embodiment defined in claim 15, according to which the stirring device comprises a hangingly supported rotor member provided with a stirring appendage arranged inside of the reaction vessel and also a toroidal stator member arranged outside of the reaction vessel, the rotor member and the stirring appendage having a central axial opening. In particular, together with the embodiment of claim 13, this allows unhindered access to the central part of a reaction mixture. A further advantage is that the lower portion of the reaction vessel is not hindered by externally arranged magnet stirrers or the like and thus is substantially more accessible.

### BRIEF DESCRIPTION OF THE DRAWINGS

Examples of the invention will be described in more detail by reference to the drawings, which show:

FIG. 1 a multiple bio-reactor device, in perspective view;

FIG. 2 a simplified representation of the device of FIG. 1, in top view;

FIG. 3 a reactor segment of a further multiple bio-reactor device, partially equipped, in perspective view;

FIG. 4 the reactor segment of FIG. 3, in a vertical central section view;

FIG. 5 a section of FIG. 4, in magnified representation;

FIG. 6 a supply vessel attached to a load cell, in longitudinal section view;

FIG. 7 a driving group of a stirring device, in longitudinal section view;

FIG. 8 a pneumatic valve, in longitudinal section view;

FIG. 9 the valve of FIG. 8, in perspective view, shown from the lower valve side;

FIG. 10 a section of four lower sector plates in the region of a 3/2-way valve, in longitudinal section view;

FIG. 11 a segment of the section of FIG. 10, in top view;

FIG. 12 a coupling symbol for the 3/2-way valve;

FIG. 13 a coupling symbol for a 2/2-way valve;

FIG. 14 a schematic tube lines and instrumentation (RI) view of the lines and valves arranged in a sector with interfaces to external lines;

FIG. 15 a filling station without lateral cover, in side view;

FIG. 16 the filling station of FIG. 15, in perspective view:

FIG. 17 a schematic RI view of the filling station of FIG. 15;

FIG. 18 a schematic RI view of a cleaning station;

FIG. 19 a schematic RI view of a calibration station;

FIG. 20 a schematic RI view of a sterilization station;

FIG. 21 a schematic RI view of an inoculation station;

FIG. 22 a schematic RI view of a sampling station.

### MODES FOR CARRYING OUT THE INVENTION

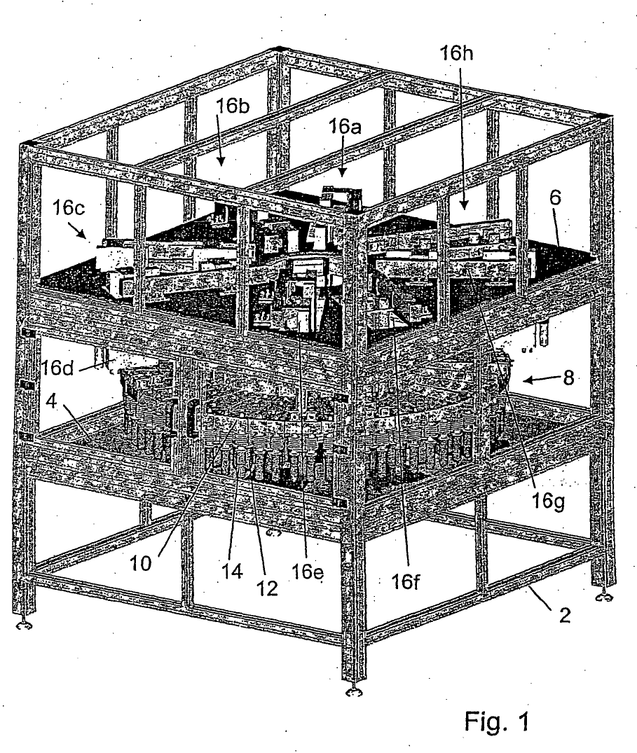

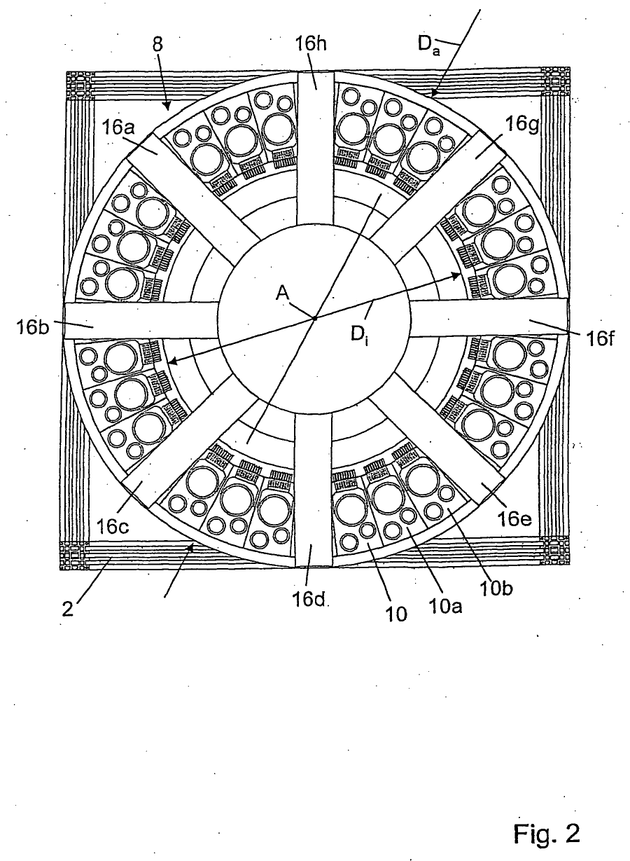

The multiple bio-reactor device shown in FIGS. 1 and 2 is arranged on a frame 2 made of beam profiles, which supports a lower platform 4 and an upper platform 6. A toroidal reactor table 8 that is substantially horizontally arranged is located between the two platforms 4 and 6. The reactor table 8 is formed of 32 identical, sector-shaped reactor segments 10, 10a, 10b, etc., and each reactor segment is intended to have a reaction vessel 12 and two supply vessels 14a and 14b attached thereto in a medium-tight suspended manner. As shown, in particular, in FIG. 2 the segments 10, 10a, 10b, etc. together form the reactor table 8 with a ring shaped section that has an internal diameter Dᵢ and an external diameter Dₐ. The reactor table 8 can be rotated about the central vertical axis A by actuator means not shown here, preferably by means of a stepper motor, and it can be positioned in any rotational position. In the example shown here the approximate ring size is Dᵢ=95 cm and Dₐ=175 cm; the frame 2 has a length and a width of about 200 cm and a height of about 240 cm.

Moreover, the bio-reactor device comprises eight processing stations 16a, 16b, 16c, 16d, 16e, 16f, 16g and 16h that are arranged star-like around the central axis A. As will be described in more detail hereinbelow, the individual processing stations are arranged above the upper platform 6. In general, each processing station comprises a lower connection that projects through a recess of the upper platform 6 and cooperates with a corresponding upper coupling point of the respective reactor segment 10, 10a, 10b, etc, arranged under the processing station. For this purpose, each one of said reactor segments can be brought to each one of the desired processing stations 16a, 16b, etc. by a rotation of the reactor table 8 about its central axis A in order to carry out predetermined processing steps on the reaction vessel 12 and/or the supply vessels 14a and 14b of the respective reactor segment.

The processing stations comprise a cleaning station 16a, a calibration station 16b, a sterilization station 16c, two filling stations 16d and 16e, an inoculation station 16f and two sampling stations 16g and 16h. The construction and function of the individual processing stations are described further hereinbelow.

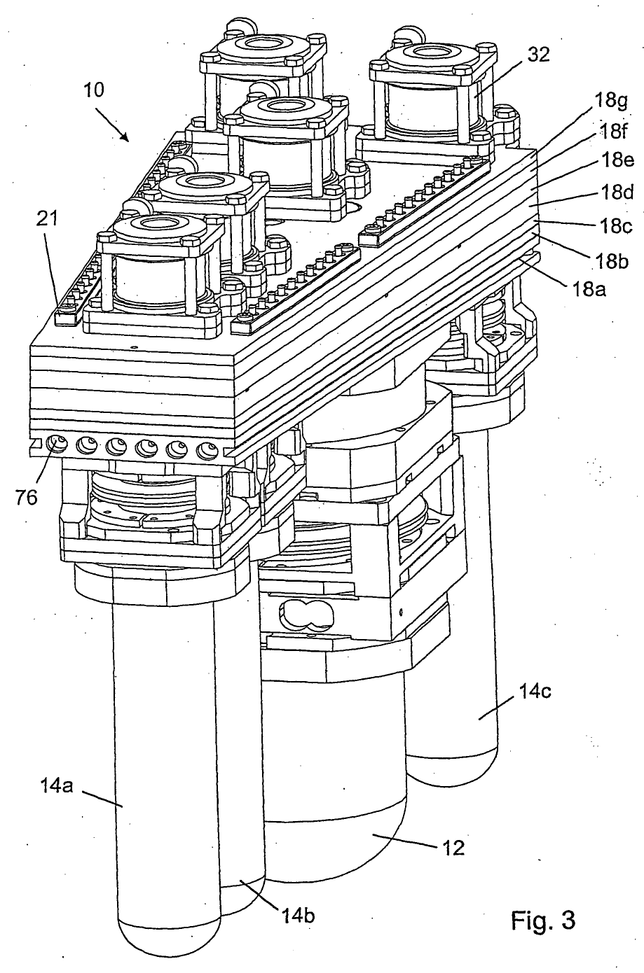

The construction principle of the individual reactor segments of a further multiple bio-reactor device is explained with reference to FIGS. 3 to 5. In contrast to the device of FIGS. 1 and 2, the reactor segments are intended to be equipped with up to four supply vessels. At the reactor segment 10 shown here, a reaction vessel 12—for example, a glass vessel with a reactor volume of 600 mL and a working volume of 200 to 400 mL—and four supply vessels 14a, 14b, 14c and 14d—for example, glass vessels with a volume of 120 mL each—are attached in a suspended manner. The reactor segment is formed of seven sector-shaped plate elements stacked on top of each other, namely, of three lower plates 18a, 18b and 18c made of stainless steel and four upper plates 18d, 18e, 18f and 18g made of aluminum. As described in more detail hereinbelow, the layer structure houses a plurality of valves 20 and channels 22 that all together define a system of lines for gases and liquids. In particular, the steel structure formed of the lowest three plates 18a, 18b and 18c comprises a sterilizable channel system in order to supply gases and liquids to the individual vessels or to drain or to remove gases and liquids from the individual vessels, respectively. The aluminum structure formed of the uppermost four plates 18d, 18e, 18f and 18g firstly serves to hold the valves 20 and secondly contains a non-sterile channel system for the distribution of pressurized air for operating the pneumatics valves 20. The access to the pressurized air system is provided via four connection groups 21 that are arranged at the upper edges of the reaction segment. The associated supply of pressurized air is provided via tubes (not shown) leading from a valve island 23 arranged at the face of the reactor segment oriented away from the central axis A.

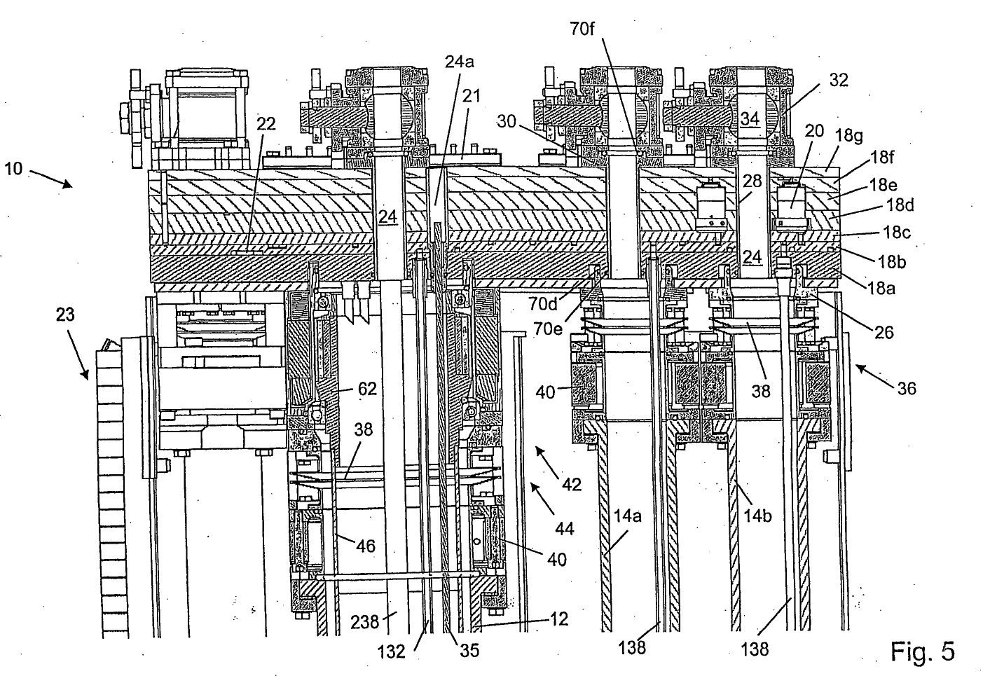

Moreover, the reactor segment 10 is provided with vertical passage openings 24 that are provided at the lower end thereof with a connection flange 26 for a vessel to be secured thereto in a suspended manner. As shown, in particular, in FIG. 5, in each passage opening 24 there is inserted a pipe stub 28 preferably made of stainless steel, whose upper collar flange 30 rests on the uppermost sector layer 18g. The upper collar flange 30 forms a support for an isolation device 32 flanged thereto, which on its part forms an upper coupling point for a connector of a processing station not shown here. Preferably, the isolation device 32 is provided as a sterilizable ball valve that in its open position clears a substantially vertical passing channel 34. A further vertical passage opening 24a serves for the insertion of a temperature probe 35, for example a Pt 100 sensor, into the reaction vessel 12.

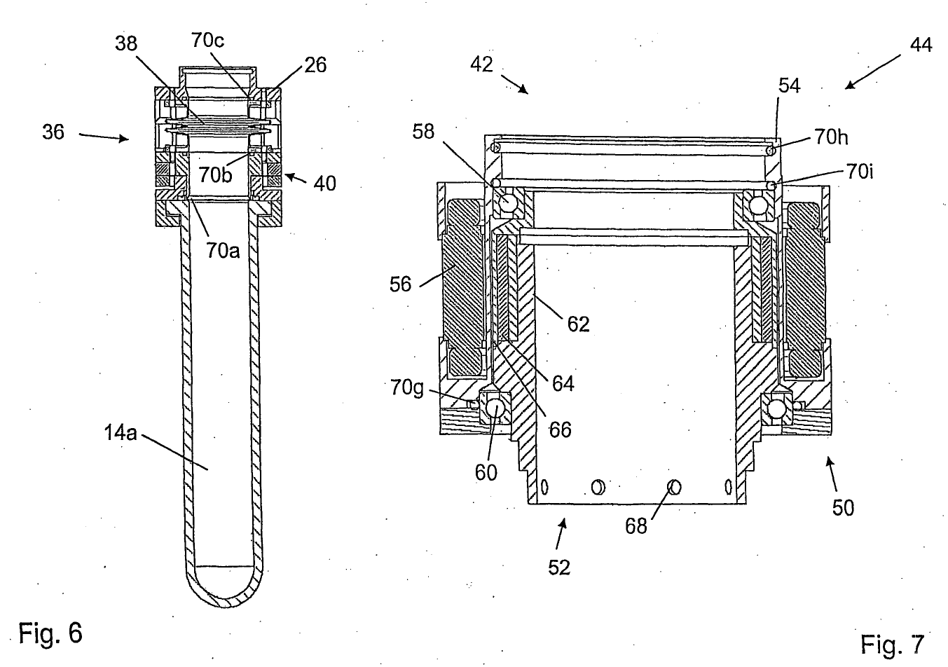

The way of attaching the supply vessels is shown in detail in FIG. 6. Between the connection flange 26 and the supply vessel 14a there is incorporated a load cell 36 that is made of an upper bellows tube 38 and a weight measuring can 40 hanging thereunder. The bellows 38 acts as elastic member whose longitudinal extension depends on the weight of the load hanging on it—namely the weight of the weight measuring can 40 and of the supply vessel 14 including its possible contents. This longitudinal extension is recorded by the weight measuring can 40, which produces a measuring signal corresponding to said gross weight.

The attachment type of the reaction vessel 12 is analogous to that of the supply vessels, although the construction units have a greater nominal width. However, the load cell 38 of the reaction vessel 12 is not attached directly to the reactor segment 10, but rather to the driving group 42 of a stirring device 44 that in turn is attached to the bottom of the lowest sector layer 18a.

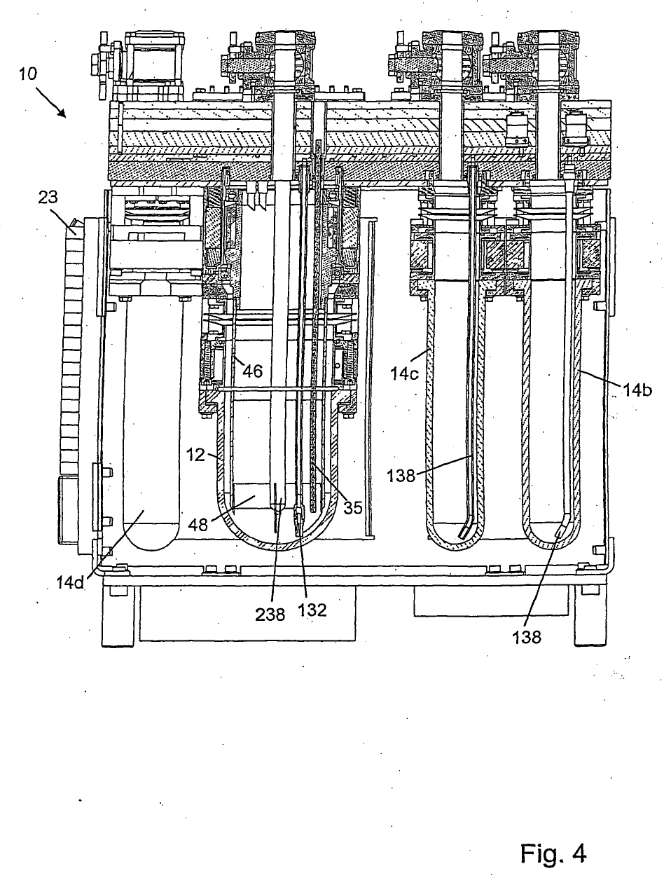

As shown in FIGS. 4 and 5, the stirring device 44 comprises a driving group 42 and a stirring appendage 46 driven by the driving group 42 and protruding into the reaction vessel 12, with the stirring appendage 46 substantially has the shape of a pipe segment. The stirring appendage 46 extends almost to the bottom of the reaction vessel 12 and is provided with stirring blades 48 at its lower portion.

The construction of the driving group 42 is shown in FIG. 7 and comprises, in particular, a stator member 50 arranged outside of the reactor cavity, and also a rotor member 52 cooperating therewith arranged inside the reactor cavity. For this purpose, there is provided a cylindrically shaped casing portion 54 that is surrounded by a stator coil 56 at its external side. Inside of the casing portion 54, the rotor member 52 is rotatably supported about the longitudinal rotor axis by means of an upper ball-bearing 58 and a lower ball-bearing 60. In particular, the rotor member 52 comprises a holding element 62 with cylinder tube shape, at the outer wall of which is attached a permanent magnet 64 that is covered by an outer shell 66. Moreover, the holding element 62 is provided at the lower end thereof with a plurality of radial boreholes 68 that are intended for the attachment of the stirring appendage 46.

As shown in FIGS. 4 to 7, the interior of the flange-mounted vessels can be kept medium-tightly isolated from the environment by using connections that are sealed with o-rings. Hence, the prerequisites for keepin sterile said internal cavity are given. For example, the supply vessel 14a is connected via a first sealing ring 70a with the measuring can 40 which is connected via a second sealing ring 70b with the bellows tube 36 which in turn is connected via a third sealing ring 70c with the connection flange 26. Moreover, the connection flange 26 is connected via a fourth sealing ring 70d with the lowest sector plate 18a. A fifth sealing ring 70e externally surrounds the lower end of the pipe stub 28 that is provided at its upper collar flange 30 with a sixth sealing ring 70f that cooperates with a lower flange surface 72 of the isolation device 32.

The sealing of the reaction vessel 12 is analogous to that of the supply vessels, albeit additional sealing rings are provided in the region of the stirring device 44. As shown, in particular, in FIG. 7, the driving group 42 is provided at a lower collar flange 74 of the casing portion 54 with a seventh sealing ring 70g. Moreover, the casing portion 54 comprises at the upper end thereof two inner grooves arranged on top to each other, the upper one of which houses an eighth sealing ring 70h. The lower groove, however, contains a ninth ring 70i that serves to pretension the ball-bearing 58 arranged thereunder.

The construction and the function of the reactor segments are described in more detail hereinbelow. Each reactor segment comprises at the front side thereof directed towards the central axis A six lateral connections 76 in order to supply the channel system arranged in the reactor segment with three ventilation gases (in particular oxygen, nitrogen and carbon dioxide) and also with sterile pressurized air, superheated water steam and optionally other gases or liquids, and to drain condensate from the channel system. The said channel system is formed in the three lower-most layers of the reactor segment, i.e. in the plates 18a, 18b and 18c made of stainless steel. In the aluminum plates 18d, 18e and 18f arranged thereabove there are inserted pneumatically operable valves 20 whose valve members cooperate with corresponding valve seats that are formed at the upper side of the uppermost steel plate 18c. The middle steel plate 18b is provided with milled channel grooves that—together with vertical boreholes in the steel plates 18a to 18c-form the channel system described in more detail hereinbelow. Various portions of the channel system can be connected to each other and isolated from each other, respectively, by the action of the valves 20.

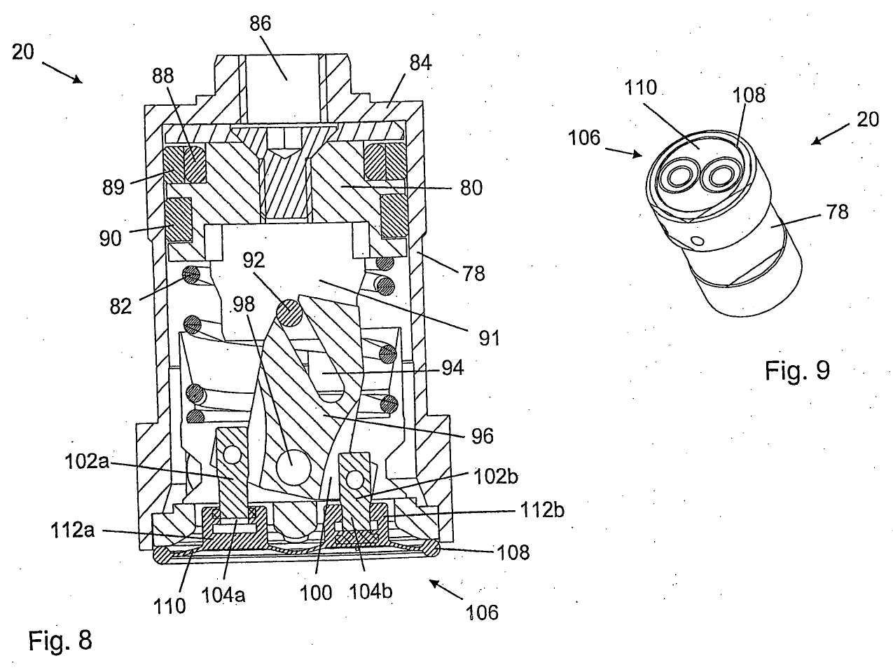

The valve 20 shown in FIGS. 8 and 9 comprises a cylindrical valve body 78 with a piston element 80 arranged therein in longitudinally displaceable fashion. A pressure spring 82 arranged inside of the valve body 78 below the piston element 80 pretensions the piston element 80 against an upper roof segment 84 of the valve body 78. An operational opening 86 arranged in roof segment 84 is provided in order to load the piston element 80 with pneumatic pressure and, thereby, to urge it downwards against the action of the pressure spring 82. An o-ring 88 with external teflon ring 89 and a guide tape 90 made of teflon is arranged in external ring grooves of the piston element 80 and acts to seal against and guide along the inner wall of the casing of the valve body 78.

Moreover, at the lower portion of the piston element 80 there is arranged a plug-like protrusion 91 that comprises a radially protruding follower pin 92 that engages in a tracking groove 94 of a rocking member 96. The rocking member 96 is tiltably supported in relation to the valve body 78 by means of a rotating pin 98 and comprises a lower cross beam 100. At each one of the two lateral ends of the cross beam 100 a bolt member 102a and 102b, respectively, is articulated. The bolt members 102a and 102b are shaped at the lower ends thereof as valve plunger 104a and 104b, respectively.

As shown in FIG. 8, valve 20 further comprises a lower sealing element 106. The latter is formed of a rubber elastic material appropriate for sealing purposes and comprises an external ring bulge 108 that surrounds a membrane 110. The membrane 110 is provided with two holding plugs 112a and 112b facing upwards, each of which being provided with an upper opening for receiving a corresponding valve plunger 104a and 104b, respectively. The sealing element 106 forms a division between a sterilizable lower domain and a non-sterile upper domain of the reactor segment.

When valve 20 is provided with pneumatic pressure from a pneumatic connection line through the operational opening 86, the piston element 80 is displaced from an upper piston position into a lower piston position against the pretensioning force of pressure spring 82. Thereby, follower pin 92 is also displaced downwards, and by cooperating with the tracking groove 94, rocking member 96 is tilted about its swivel axis defined by rotating pin 98. In this way, the left side of cross beam 100 is displaced downwards and simultaneously the right side of cross beam 100 is displaced upwards, and thus the left valve plunger 104a is displaced down-wards and the right valve plunger 104b is displaced upwards.

If the pneumatic pressure is now released via the pneumatic connection line, then the piston element 80 is displaced into the upper piston position thereof due to the pretensioning force of the spring 82, as shown in FIG. 8. Thereby the rocking member 96 is displaced again due to the cooperation of the follower pin 92 and tracking groove 94, and the right valve plunger 104b is now pressed downwards, whereas the left valve plunger 104a is raised.

As already mentioned above, valve plungers 104a and 104b are connected medium-tightly with the lower sealing element 106 via the holding plugs 112a and 112b, respectively, so that the portion of the membrane 110 in the vicinity of the valve plunger is raised and pressed down, respectively. Therefore, the portion of the sealing element 106 presently pressed down allows to provide a medium-tight closure against an associated valve seat; and, vice versa, a medium passage that was previously closed can be released by raising a portion of the sealing element 106. At the same time, the membrane 110 forms a medium-tight closure of the valve 20 in any position of the rocking members 96, i.e. the valve cavity does not come into contact with the medium controlled by the valve.

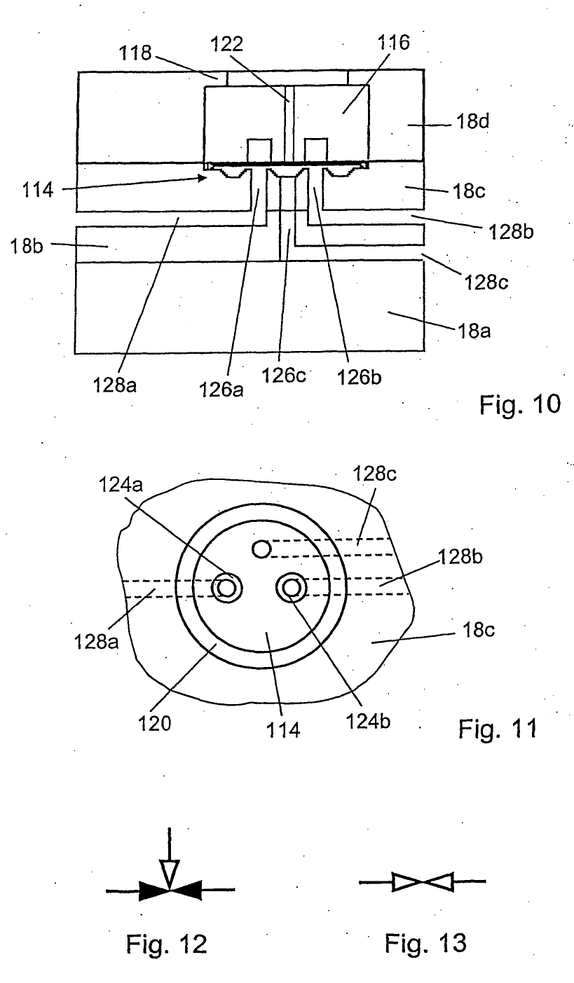

The application of the above described valve for a 3/2-way coupling will now be explained in more detail with reference to FIGS. 10 and 11.

FIG. 10 shows a vertical section through the lowermost four layers of a reactor segment 10, i.e. through the three steel plates 18a, 18b, 18c and through the lowermost aluminum plate 18d. At the upper side of the uppermost steel plate 18c there is provided a circular milled recess 114, into which can be inserted the lower portion of a valve 20 that is only shown partially here. The lowermost aluminum plate 18d arranged thereabove comprises a receiving bore 116 with an upper shoulder 118 that overlaps the lower portion of the valve 20. The dimensions are chosen in such a way that by joining the lowermost aluminum plate 18d with the uppermost steel plate 18c the ring bulge 108 of the sealing element 106 of the valve 20 is pressed against a peripheral flange surface 120 of the milled recess 114. Thus, the ring bulge 108 forms a medium-tight closure in the peripheral region of the milled recess 114.

With the valve inserted, the upper portion thereof that is not shown here protrudes upwards through the aluminum plate 18d and extends into the aluminum layers 18e and 18f lying thereabove, which house the pneumatics connection line required for the operation of the valve.

The wall of the receiving bore 116 can further comprise a guiding groove 122 in which can engage, for example, the rotating pin 98 of the rocking member 96. In this way, an accurate alignment of the valve plungers 104a and 104b respectively, can be achieved in respect of the associated valve seats 124a and 124b, respectively, that are formed at the upper side of the uppermost steel plate 18c.

The left valve seat 124a surrounds the upper aperture of a first vertical passage bore 126a of the upper steel plate 18c that leads into a first horizontal milled groove 128a at the upper side of the middle steel plate 18b. The right valve seat 124b surrounds the upper aperture of a second vertical passage bore 126b of the upper steel plate 18c that leads into a second horizontal milled groove 128b at the upper side of the middle steel plate 18b. Moreover, a third vertical passage bore 126c passing through the upper steel plate 18a and the middle steel plate 18b and leading into a third horizontal milled groove 128c at the bottom side of the middle steel plate 18b is arranged in the central region of the milled recess 114.

As will be explained in more detail hereinbelow, the three steel plates 18a, 18b and 18c are soldered together, but the circular milled recess 114 and also the channel-shaped longitudinal milled grooves 128a, 128b and 128c are kept free, i.e. are not covered by solder. Therefore, the milled grooves arranged between the layers soldered together form a medium-tight channel system.

The operation of the 3/2-way coupling will now be explained hereinbelow with additional reference to FIG. 8. In the resting position of the pneumatics valve 20, i.e. with no pneumatic pressure applied, the right valve plunger 104b is pressed down, so that the right valve seat 124b and the upper aperture of the second vertical passage bore 126b are closed in medium-tight fashion. At the same time, the left valve plunger 104a is raised and, thus, the left valve seat 124a and the upper aperture of the first vertical passage bore 126a respectively, are released. Thus, in the resting position of the valve there is a connection between the channel defined by first horizontal milled groove 128a and the channel defined by the third horizontal milled groove 128c. In contrast, with pressure loaded pneumatics valve the left valve plunger 104a is pressed down. Thus, the left valve seat 124a and the upper aperture of the first vertical passage bore 126a are closed in medium-tight fashion and, at the same time, the right valve seat 124b and the upper aperture of the second vertical passage bore 126b are released. Therefore, in the pressure loaded position of the valve, there is a connection between the channel defined by the second horizontal milled groove 128b and the channel defined by the third horizontal milled groove 128c. Therefore, the 3/2-way coupling described here allows to exclusively connect the third line 128c optionally with first line the 128a or with the second line 128b. The corresponding coupling symbol is shown in FIG. 12.

The functional principle explained with reference to FIGS. 10 and 11 can be realized analogously for construction of a 2/2-way coupling. For this purpose one leaves out, for example, the first line 128a so that the left valve seat 124a has no effect or can be replaced by an upper section of the upper steel plate 108c. Therefore, the connection between the third line 124c and the second line 124b is closed in the resting position of the pneumatic valve 20 and can be cleared by pneumatic load of the valve 20. The corresponding coupling symbol is shown in FIG. 13.

If required, the 2/2-way coupling can also be modified in such a way that the switched connection is released in the resting position of the pneumatics valve 20 and is closed upon pneumatic load of the valve. For this purpose, the valve has to be installed in a position rotated by 180° in respect of the longitudinal axis, so that now the valve portion formerly termed as the left valve plunger 104a is arranged above the single valve seat 124b of the 2/2-way coupling.

As already mentioned, the three lowermost layers of each reactor segment that are made of stainless steel are provided with boreholes and milled grooves which together with valves of the before mentioned type form a sterilizable channel system. The steel layers are soldered together, for which purpose the following hard soldering process is preferably used.

In a first processing step, the steel plates that are already provided with all the required boreholes and milled grooves are solution-annealed. In order to achieve a planarity of the sector layers of better than 0.05 mm, the sector layers are subsequently lapped. Such a planarity of the steel layers is mandatory for soldering of the sector layers by means of a thin soldering foil, because otherwise no durable and medium-tight connection of the sector layers can be achieved. In a second processing step, the soldering foil that is provided with cut-outs and recesses for the milled grooves and boreholes that have to be kept free of solder is inserted between the sector layers to be soldered. Advantageously, a soldering foil made of nickel or gold with a thickness of about 0.05 mm is used. In a third processing step, the sector layers joined together in such a way are heated in a vacuum furnace to a temperature of about 1050° C. so that the sector layers become soldered together.

Advantageously, below the soldered steel layers there is attached a heating foil, not shown here, that assists the sterilization of the channel system. For this purpose, the heating foil is heated to at least 121° C. in order to sterilize the channels, boreholes and valve seats arranged in the reactor segment. Accordingly, the separation between sterile and non sterile sector divisions runs along the border between the uppermost steel layer 18c and the lowermost aluminum layer 18d; the valve seats and the membrane sides of the valves adjacent to the valve seats belong to the sterilizable sector division.

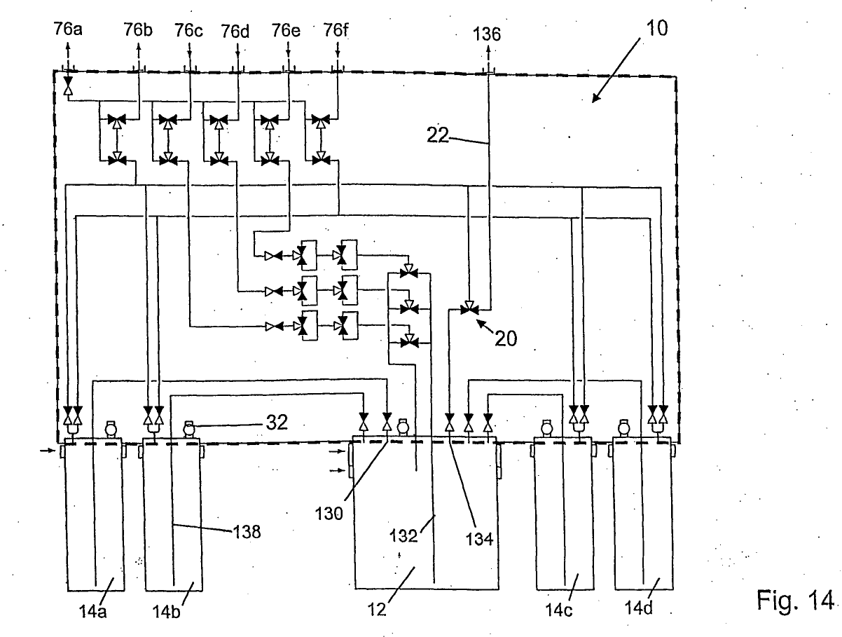

As shown in FIG. 4 and the corresponding tubing and instrumentation scheme (RI Scheme) of FIG. 14, the reaction vessel 12 is provided with supply pipes 130 and with a vent pipe 132 that are connected to channels and boreholes of the channel system in the associated reactor segment and serve for the supply of gases or liquids. The supply pipes 130 end in a portion of the vessel lying above the liquid or media levels and advantageously comprise an obliquely cut lower end, so that the draining and dripping behavior of the supplied liquids is improved. The vent pipe 132 substantially extends to the bottom of the reaction vessel 12. Exhaust air can be discharged from the reaction vessel 12 via an extraction opening 134 and, if required, conducted via a 3/2-way valve to an upper extraction point 136 (not shown in FIG. 4) that is intended, in particular, for connecting to a an exhaust air analysis station not shown here.

The supply vessels 14a to 14d in the example shown are not actually provided with any supply pipes as the supply of gases or liquids occurs via a passage bore in the lowest steel plate 18a connected with the channel system of the reaction segment. Moreover, the supply vessels 14a to 14d each are provided with a riser tube 138 by means of which the liquid present in the vessel can be extracted. For this purpose, the riser tubes 138 substantially extend to the bottom of the corresponding supply vessel. For the extraction of liquid, the interior of the vessel is loaded with pressurized air via the upper supply point, so that the liquid being in the vessel is pressed into the riser tube 138 and thus is trans-ported out of the vessel.

The schematic construction of the sterilizable channel system arranged in each reactor segment is shown in FIG. 14. The hatched rectangle represents the layer system formed of plates of the respective reactor segment, i.e. the components drawn within the rectangle are integrated by construction in the respective layer system.

The reactor segment 10 shown comprises seven connection points, namely, the six lateral connections 76 shown in FIG. 3 that are arranged at the front side of the segment directed to central axis A and also the upper extraction point 136 arranged at the upper side of the reaction segment. For better comprehension, the lateral connections are denoted with separate reference numerals 76a to 76f hereinbelow. Moreover, a reaction vessel 12 and four supply vessels 14a to 14d and the components such as supply pipe 130, vent pipe 132, extraction pipe 134 and riser tube 136 and also the upper isolation devices 32 already mentioned are shown in FIG. 14.

The channel system of FIG. 14 comprises a number of channels that are formed in the steel layer of the reaction segment by horizontally milled grooves and vertical boreholes. Moreover, the channel system comprises 3/2-way valves acting as switch point members and also 2/2-way valves acting as isolation members that are shown together with the coupling symbols shown in FIGS. 12 and 13. By appropriate setting of said switch point and isolation members, a plurality of operations required for the handling of the bio-reactor device can be carried out.

For the sterilization of a reactor segment, the connections 76b to 76f are supplied with superheated steam while connection 76a is used to discharge condensate. For the subsequent operation steps, the connections 76a, 76c, 76d, 76e and 76f are used for the supply of gases (e.g. carbon dioxide (CO₂), nitrogen gas (N₂), air/oxygen, sterile pressurized air), whereas connection 76b serves for discharging exhaust air. The supply of the individual connections occurs via a sterilizable ring line arranged in the portion of the bio-reactor device close to the axis. The ring line comprises a plurality of flexible line tubes that are provided with branchings for the individual reactor segments. The line tubes are arranged in such a way that the reactor table can perform at least one full rotation without hindrance.

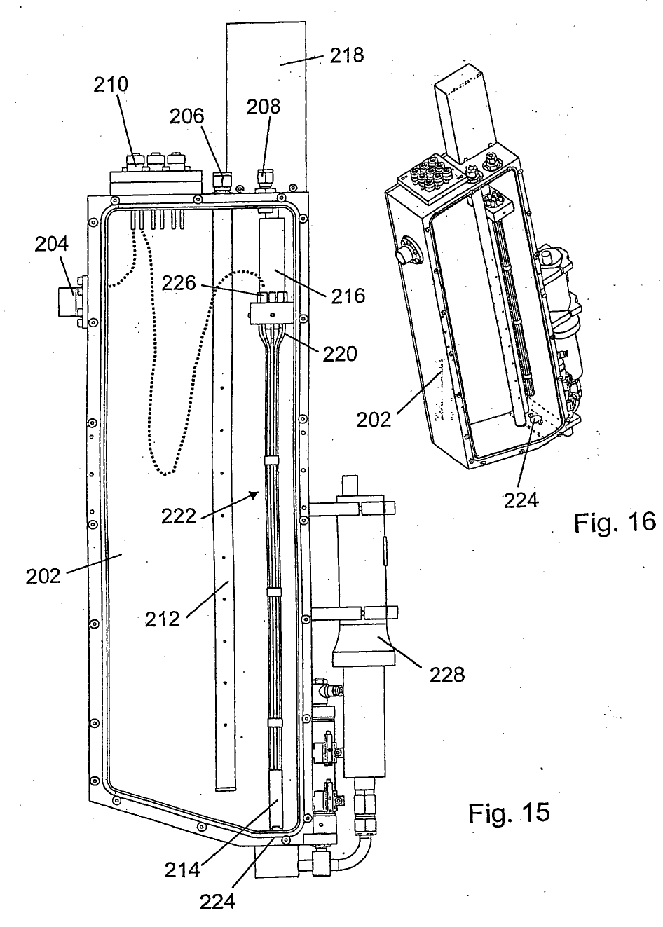

The construction of the filling station 16d (or 16e) is shown in FIGS. 15 and 16. It comprises a housing 202 made of stainless steel that in its upper portion comprises a lateral multiple feedthrough 204 for a tube bundle not shown here and that further comprises two single feedthroughs 206 and 208 at the top side. Moreover, also at the top side of the housing 202 there is arranged a group of nine dosing valves 210. The first single feedthrough 206 leads into a longitudinal pipe 212 that extends to near the bottom of the housing. The longitudinal pipe 212 is provided with lateral openings and serves for the supply of superheated steam during sterilization of the filling station.

Moreover, the filling station comprises a slide 216 that is vertically movable through a shaft 214 that can be shuttled between the upper position shown here and a lower position not shown here by means of a stepper motor 218. The slide 216 comprises a group of dripping pipes 220 that are combined to a bundle 222. An opening 224 at the bottom of the housing forms a passage for the tube bundle 222 when the latter is lowered by means of the slide 216. When the filling station 16d is ready for use, it is (provided) with connection tubes leading from the lateral feedthrough 204 to the dosing valves 210 and from there to a group of connecting portions 226 that lead into the individual dripping pipes 220. Because of the raising and lowering movement to be carried out by the slide 216, the connection tubes have to be flexible and to have sufficient length. One such connection tube is shown in FIG. 15 as a dotted line.

If required, a heating apparatus 228 provided with pressurized air supplies hot air to the region directly below the lower opening 224. Finally, there is also provided a lateral cover, not shown here, that forms a lateral closure for the housing 202.

Upon filling of a reaction vessel 12, the corresponding reactor segment is first moved towards a position under the filling station 16d until the isolation device 32 arranged above the reaction vessel is situated exactly underneath the lower opening 224. The air gap remaining between the bottom of the housing 202 and the isolation device 32 is blown at with hot air, so that sterile conditions are achieved also in this coupling region. Subsequently, the isolation device 32 is opened and the tube bundle 222 is lowered into the reaction vessel 12 by actuating the stepper motor 216, whereupon the filling can be carried out. Finally, the tube bundle 222 is raised again and the isolation device 32 is closed.

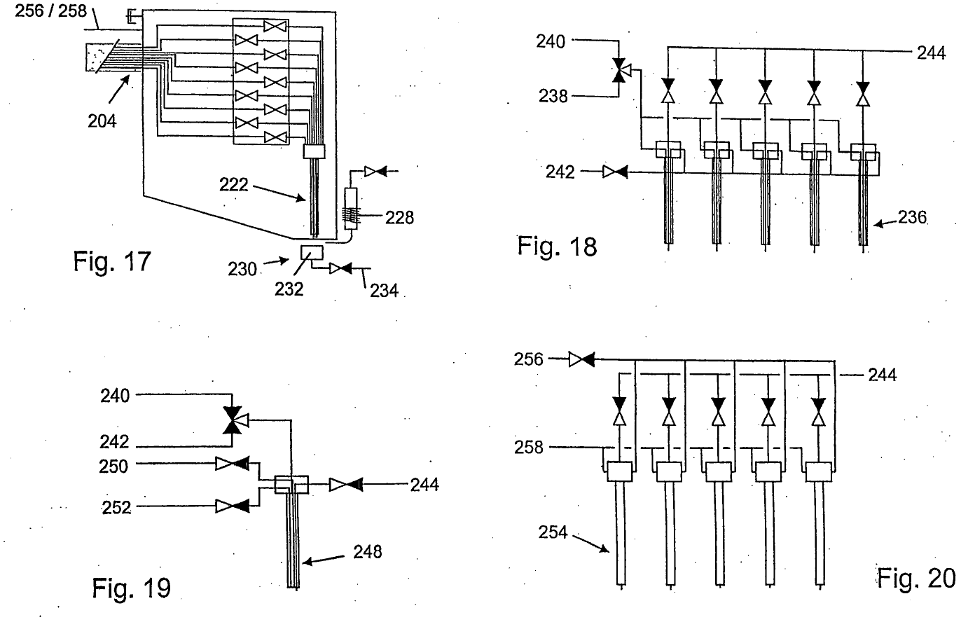

The operating principle of the filling station 16d is summarized in the schematic representation of FIG. 17 with reference to the corresponding reference numerals. Moreover, a parking station 230 not previously mentioned that comprises a receiving can 232 and a draining line 234 is shown in FIG. 17. The parking station 230 is arranged radially outside the reactor table 8 and can be reached by a radial displacement of the filling station 16d. The parking station 230 is used when initially the filling station 16d is treated with superheated steam via the longitudinal pipe 212, and it serves for the collection of the condensate running out of the lower opening 224.

The functioning principle of the various processing stations is now explained with reference to FIG. 17 to 22. The constructive embodiment of these processing stations is analogous to that of the filling station, i.e. corresponding functions (e.g. raising and lowering of an handling finger) are solved with the same or equivalent means (e.g. with a slide powered by a stepper motor or a pneumatic linear unit).

The cleaning station 16a shown in FIG. 18 serves to clean the individual reactor segments by using the known CIP procedure. The cleaning station 16a comprises five cleansing fingers 236 that can be raised and lowered, and each one thereof can be inserted into an associated supply or reaction vessel of the respective reactor segment and can be sealed with respect to the outer environment. Each cleansing finger is provided with connections for cleansing solution 238 (for the removal of impurities), water 240 (for rinsing out the vessel) and pressurized air 242 (in order to transport liquids out of the vessels via a draining line 244). The cleaning station 16a operates in a non-sterile mode.

The calibration station 16b shown in FIG. 19 serves to calibrate the pH probe (shown in FIG. 3 with reference numeral 246) immersed into the reaction vessel. Therefore, the reaction vessel 12 is serviced by a calibration finger 248 that can be lowered thereinto. Generally, a known two-point calibration with two different buffers is carried out. The calibration finger 240 is provided with connections for two buffer solutions 250, 252 (for the actual calibration), water 240 (for rinsing out the vessel) and pressurized air 242 (in order to transport liquids out of the vessels via a draining line 244). The calibration station 16b operates in a non-sterile mode.

The sterilization station 16c shown in FIG. 20 serves to sterilize the individual reactor segments by means of superheated steam. The sterilization station 16c comprises five sterilization fingers 254 that can be raised and lowered, and each one thereof can be inserted into a corresponding supply or reaction vessel of the respective reactor segment and can be sealed with respect to the outer environment. Each sterilization finger is provided with connections for superheated steam 256 (for the actual sterilization) and for sterile pressurized air 258 (in order to transport condensate out of the reaction vessel via a draining line 244). The sterilization station 16c operates in a non-sterile mode initially, but in a sterile mode after sterilization.

The already described filling station 16d (or 16e) shown in FIG. 17 serves to fill the vessels arranged on a reactor segment with up to 9 different media from corresponding containers. The filling station 16d comprises a single filling finger comprised of the tube bundle 222 which can be raised and lowered. In order to service each one of the vessels of the reaction segment, the filling station 16d can be displaced and positioned in radial direction by means of a linear unit. Before use, the filling station is sterilized with superheated steam 256 while condensate formed flows away via parking station 230. Subsequently, an overpressure is maintained by supplying sterile pressurized air 258 in order to keep the filling station sterile also during the filling of a vessel. The various tubes of the filling station are sterilized with steam from the inside and the outside before use. The vessels with the individual media components are connected in a sterile mode by means of a commercially available tube welding machine. The filling station 16d operates in a sterile mode.

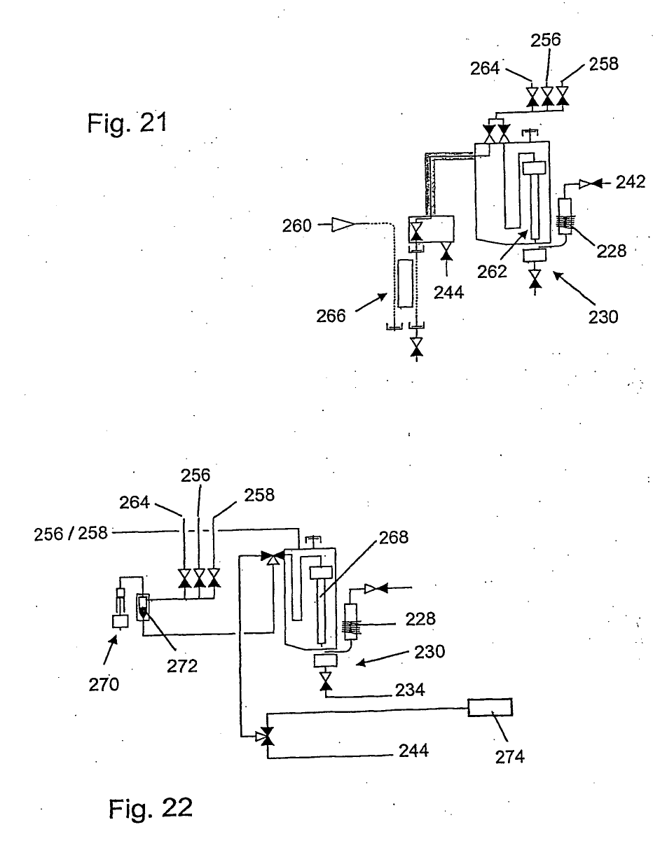

The inoculation station 16f shown in FIG. 21 serves to supply a preculture 260 into the reaction vessel 12. The inoculation station 16f comprises a single inoculation finger 262 that can be raised and lowered and is provided with a linear unit operating in radial direction like the one of filling station 16d, so as to be positioned above the reaction vessel. Like with the filling station, the inoculation station is initially sterilized above a parking station 230 by treating all lines with superheated steam 256, sterile water 264 and sterile air 258. The preculture container is connected in a sterile mode by means of a tube welding machine 266.

The sampling station 16g (or 16h) shown in FIG. 22 serves to extract a sample from the reaction vessel 12. The sampling station 16g comprises a single extraction finger 268 that can be raised and lowered and is provided with a linear unit operating in radial direction like the one of filling station 16d, so as to be positioned above the reaction vessel. Like with the filling station, the sampling station is initially sterilized above a parking station 230 by treating all lines with superheated steam 256, sterile water 264 and sterile air 258. By using an syringe module 270, a sample is extracted from the reaction vessel 12 via the extraction finger into a cuvette 272 and then transported to an analyzer 274 or optionally to the drain 244.

In addition to the components described above, the multiple bio-reactor device comprises a plurality of components serving, in particular, for the control and supply of the various device groups. In particular, a computer based controller not shown here is provided to control the preparation and execution of the bio-reactor experiments. Moreover, an appropriate supply with electricity, liquids and gases is needed so as to operate the multiple bio-reactor device.

The multiple bio-reactor device described above allows a substantially automated operation. In the so-called “single clone” mode, all 32 reaction vessels are inoculated with the same clone. This allows, in particular, to study the effect of different reaction conditions. In contrast, in the so-called “multi clone” mode, the individual reaction vessels are inoculated with different clones, in which case all reaction vessels are set up e.g. with the same reaction conditions.

Normally, the operation sequence comprises the following steps:
cleaning (CIP) the reactor segments and the vessels attached thereto and also all the supply lines including the ring line;
calibrating the pH sensors with non sterile buffer solutions;
sterilizing (SIP) the filter and processing stations and also the entrances of all the reactor segments;
sterilizing (SIP) (in sequence) the individual reactor segments and the lines provided therein and also the vessels attached thereto by means of the sterilization station;
composing media (gravimetrically controlled by means of the integrated load cells) and filling the vessels;
calibrating the oxygen sensors (if present) by exposing to nitrogen gas and to air and oxygen respectively;
inoculation;
running the bioreactions.

Each reaction vessel is enabled under operating conditions thereof with the following basic functions:
stirring;
tempering;
venting (submersed or “headspace”) with up to 3 different gases, wherein the dosing in the channel system of the reaction segment occurs by selecting one or more supply paths provided with different flow restrictions, and optionally a pulse/pause modulation;
additionally dosing acids and bases by means of a pulse/pause modulation;
supplying individual media components by means of a pulse/pause modulation.

Each supply vessel is enabled under operating conditions thereof with the following functions:
periodic gravimetric recording of all dosed components (acids, bases, media components, media, starting material);
refilling of used acid, base, media components, used media, starting material into the supply vessels.

List of reference numerals
2 upper frame
4 lower platform
6 upper platform
8 reactor table
10, 10a, . . . sector of 8
12 reaction vessel
14a, 14b, . . . supply vessel
16a cleaning station
16b calibration station
16c sterilization station
16d, 16e filling station
16f inoculation station
16g, 16h sampling station
18a, 18b, . . . sector layer
20 valve
21 connection group for pneumatics
22 channel
23 valve island for pneumatics
24, 24a passage opening in 10
26 connection flange
28 pipe stub
30 upper collar flange of 28
32 isolation device
34 passage channel of 32
35 temperature probe
36 load cell
38 bellows tube
40 weight measuring can
42 driving group of 44
44 stirring device
46 stirring appendage of 44
48 stirring blades of 44
50 stator member of 42
52 rotor member of 42
54 casing portion of 42
56 stator coil
58 upper ball-bearing of 52
60 lower ball-bearing of 52
62 holding element of 52
64 permanent magnet of 52
66 external shell of 52
68 radial boreholes in 62
70a, 70b, . . . sealing ring
72 lower flange surface of 32
74 lower collar flange of 54
76 connections for 22
78 valve body
80 piston element
82 pressure spring
84 roof segment of 78
86 operational opening
88 o-ring of 80
89 teflon ring of 80
90 guide tape of 80
91 plug-like protrusion
92 follower pin
94 tracking groove
96 rocking member
98 rotating pin
100 cross beam
102a, 102b bolt member
104a, 104b valve plunger
106 sealing element
108 ring bulge of 106
110 membrane of 106
112a, 112b holding plug of 106
114 milled recess for 20
116 receiving bore of 18d
118 upper shoulder of 116
120 peripheral flange surface of 114
122 guiding groove
124a, 124b valve seats
126a, 126b, 126c vertical passage bore
128a, 128b, 128c horizontal milled groove=line
130 supply pipe for 12
132 vent pipe for 12
134 extraction opening
136 extraction point of 132
138 riser tube for 14a, 14b
202 housing of 16d
204 multiple feedthrough
206 single feedthrough
208 single feedthrough
210 dosing valve
212 longitudinal pipe for superheated steam
214 shaft
216 slide
218 stepper motor
220 dripping pipe
222 tube bundle
224 lower opening of 202
226 connecting portions for 220
228 heating apparatus
230 parking station
232 receiving can
234 draining line
236 cleansing finger
238 pH probe
240 water
242 pressurized air
244 drain
246 pH probe
248 calibration finger
250 buffer 1
252 buffer 2
254 sterilization finger
256 superheated steam
258 sterile pressurized air
260 preculture
262 inoculation finger
264 sterile water
266 tube welding device
268 extraction finger
270 injection module
272 cuvette
274 analyzer

1. A multiple bio-reactor device comprising a plurality of reaction vessels, characterized in comprising a plurality of reactor segments, wherein a reaction vessel and at least one supply vessel can be secured to each reactor segment in a medium-tight suspended manner, and further comprising a plurality of processing stations for carrying out predetermined processing steps with respect to the reaction vessel and/or the supply vessels of each reactor segment, wherein actuator means are provided for bringing each reactor segment to a respective processing station or vice-versa, each reactor segment comprising a sterilizable domain which encompasses at least the reaction vessel and part of the reaction segment located thereabove.

2. The device of claim 1, characterized in that the individual reactor segments are sector-shaped and together form a substantially toroidal reactor table.

3. The device of claim 2, characterized in that the processing stations are arranged star-like around a central axis of the reactor table, wherein reactor segments and processing stations can be brought to each other by a rotation about the central axis.

4. The device of claim 1, characterized in that the processing stations are selected from the group consisting of: cleaning station, calibration station, sterilization station, filling station, inoculation station and sampling station.

5. The device of claim 1, characterized in that each reactor segment is formed of several segment layers stacked on top of each other, wherein the individual segment layers are provided with milled grooves and/or boreholes and/or isolation elements that form a channel system for liquids and/or gases.

6. The device of claim 5, characterized in that a number of lower segment layers are made of stainless steel and form part of the sterilizable domain.

7. The device of claim 5, characterized in that the channel system comprises a ring line for supplying and draining gases from a central injection point to the individual reactor segments.

8. The device of claim 5, characterized in that each reactor segment is provided with pneumatically operated valves, each valve cooperating with at least one corresponding contact portion acting as a valve seat of a segment layer.

9. The device of claim 8, characterized in that the valves are arranged within the reaction segment, wherein a number of upper segment layers houses a pneumatics distribution system for controlling the valves.

10. The device of claim 8, characterized in that each valve comprises a rocking member that can be brought into a first and a second rocking position, respectively, by applying and releasing a pneumatic pressure, respectively, wherein the rocking member is connected to at least one plunger element in such a way that the plunger element in one of the two rocking positions forms a medium-tight closure with the corresponding contact portion and that the plunger element in the other one of the two rocking positions releases the medium-tight closure.

11. The device of claim 1, characterized in that it is provided with tube-like load cells, wherein each load cell forms a medium-tight connection between a reactor segment and a reaction vessel or supply vessel secured thereto.

12. The device of claim 1, characterized in that each reactor segment is provided with at least one sterilizable coupling unit in order to form a connection between a reaction vessel or supply vessel arranged at said reactor segment and a processing station arranged thereabove, wherein said connection optionally can be maintained sterile.

13. The device of claim 12, characterized in that the coupling unit comprises a ball valve that in its open position clears a substantially vertical passing channel.

14. The device of claim 1, characterized in comprising a respective stirring device for each reaction vessel.

15. The device of claim 16, characterized in that the stirring device comprises a hangingly supported rotor member provided with a stirring appendage arranged inside of the reaction vessel and also a toroidal stator member arranged outside of the reaction vessel, wherein rotor member and stirring appendage have a central axial opening.
